(19) United States
(12) Patent Application Publication
(10) Pub. No.: US 2010/0115144 A1
(43) Pub. Date: May 6, 2010

(54) Wireless Switch State Using Controller Powered with System in Various Low-Powered States

(76) Inventors: Justin Tyler Dubs, Durham, NC (US); Steven Richard Perrin, Raleigh, NC (US); James Joseph Thrasher, Efland, NC (US); Michael Terrell Vanover, Raleigh, NC (US)

Correspondence Address: LENOVO - JVL;C/O VANLEEUWEN & VANLEEUWEN, P.O. BOX 90609, AUSTIN, TX, 78709-0609, US

(21) Appl. No.: 12/263,142

(22) Filed: Oct. 31, 2008

(51) Int. Cl. G06F 3/00

(52) U.S. Cl. 710/8; 710/1

(57) ABSTRACT

A computer system detects a power state change and determines that the power state change puts the computer system in a low power state. In turn, the computer system informs an external slot device to enable an external wireless device included in the external slot device.

### BACKGROUND OF THE INVENTION

1. Technical Field

The present invention relates to controlling an internal wireless device and an external wireless device when a computer system is in various power states. More particularly, the present invention relates to powering the external wireless device included in an external slot device when the computer system is in a low power state in order to maintain communication with a mobile device.

2. Description of the Related Art

In an increasingly connected world, computing devices no longer power down completely. Instead, many computing devices enter low power states such as S2/3 (sleep modes) and S4 (hibernate mode). Other devices may be externally connected to a computing device through the computing device's ports or slots that receive power from the computing device. For example, a laptop computer may have an ExpressCard slot in which a user may insert an ExpressCard. In this example, the ExpressCard may include a wireless transceiver, such as a Bluetooth transceiver, that the computing device utilizes in order to wirelessly communicate with other devices.

### SUMMARY

A computer system detects a power state change and determines that the power state change puts the computer system in a low power state. In turn, the computer system informs an external slot device to enable an external wireless device included in the external slot device.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 is a diagram showing a computer system powering an external slot device in a low power state;

FIG. 3 is a table showing various configurations of an internal wireless device and components included on an external slot device;

FIG. 4A is a diagram showing a computer system communicating with a mobile device in a high power state through an internal wireless device;

FIG. 4B is a diagram showing a computer system communicating with a mobile device in a low power state through an external slot device's external wireless device;

FIG. 5 is a high-level flowchart showing steps taken in configuring a computer system's internal wireless device and an external wireless device based upon the computer system's power state and wireless state;

FIG. 6 is a flowchart showing steps taken in configuring an internal wireless device and an external wireless device based upon a power state change; and

FIG. 7 is a flowchart showing steps taken in configuring an internal wireless device and an external wireless device based upon a wireless state change.

### DETAILED DESCRIPTION

Certain specific details are set forth in the following description and figures to provide a thorough understanding of various embodiments of the invention.

Certain well-known details often associated with computing and software technology are not set forth in the following disclosure, however, to avoid unnecessarily obscuring the various embodiments of the invention. Further, those of ordinary skill in the relevant art will understand that they can practice other embodiments of the invention without one or more of the details described below. Finally, while various methods are described with reference to steps and sequences in the following disclosure, the description as such is for providing a clear implementation of embodiments of the invention, and the steps and sequences of steps should not be taken as required to practice this invention. Instead, the following is intended to provide a detailed description of an example of the invention and should not be taken to be limiting of the invention itself. Rather, any number of variations may fall within the scope of the invention, which is defined by the claims that follow the description.

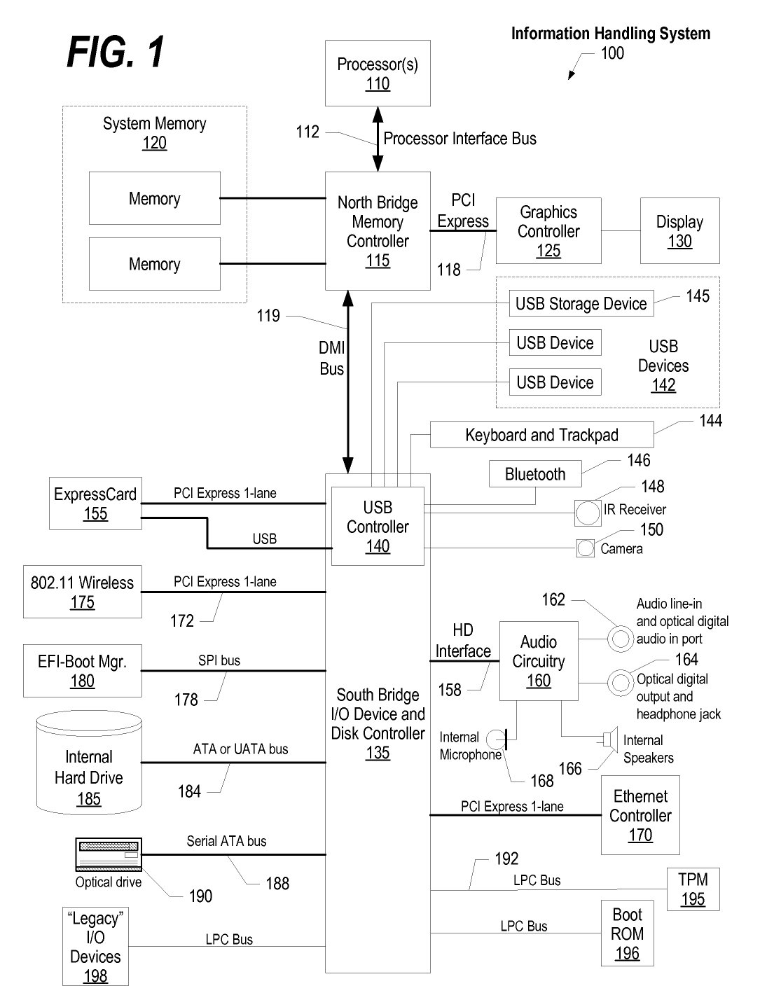

The following detailed description will generally follow the summary of the invention, as set forth above, further explaining and expanding the definitions of the various aspects and embodiments of the invention as necessary. To this end, this detailed description first sets forth a computing environment in FIG. 1 that is suitable to implement the software and/or hardware techniques associated with the invention.

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.”

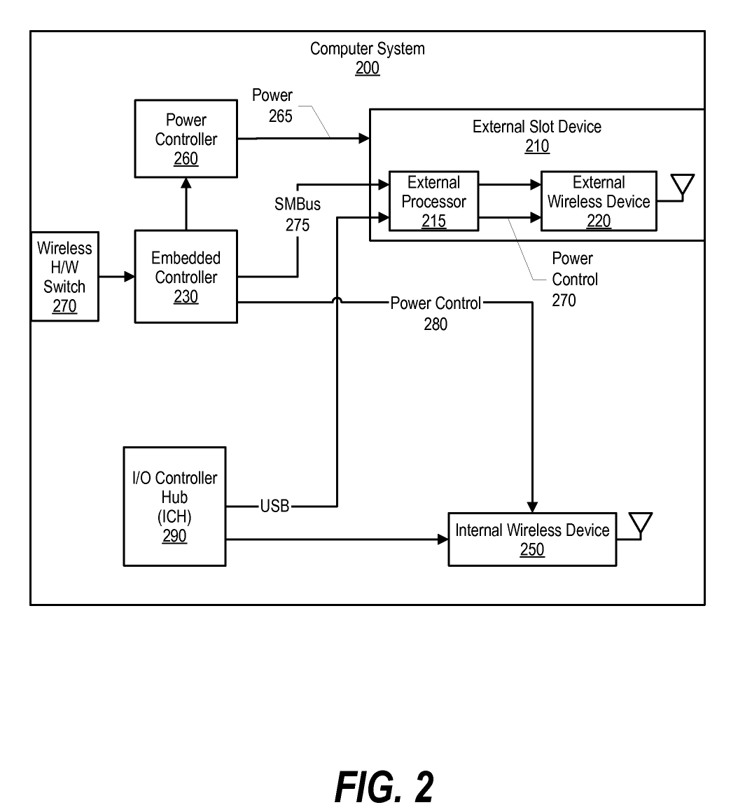

FIG. 2 is a diagram showing a computer system powering an external slot device in a low power state. Computer system 200, such as a laptop computer, is capable of communicating with other wireless devices (e.g., mobile phones, printers, etc.) through a wireless network, such a Bluetooth network. Computer system 200 includes internal wireless device 250 and also includes a slot (e.g., ExpressCard slot, PCMCIA card slot, etc.) in which to insert external slot device 210. The example shown in FIG. 2 shows that external slot device 210 includes external processor 215 and external wireless device 220. The invention described herein allows computer system 200 to utilize internal wireless device 250 during high power states and utilize external wireless device 220 during low power states (e.g., S3, S4, or S5 states). Due to particular wireless standards, the invention described herein prohibits both internal wireless device 250 and external wireless device 220 to be enabled simultaneously.

When computer system 200 is in the high power state, input/output controller hub (ICH) 290 acts as a USB host and enables/disables internal wireless device 250 based upon software wireless state changes. For example, a user may enable or disable the computer system 200's wireless state through a graphical user interface. When this occurs, ICH 290 sends wireless state change information to internal wireless device 250 and external processor 215 through a USB bus. Although computer system 200 is in a high power state, external processor 215 still logs the wireless state change for later use when computer system 200 enters a low power state. In one embodiment, computer system 200 may send the wireless state change indicator to external slot device 210 through other means, such as a hardwired signal.

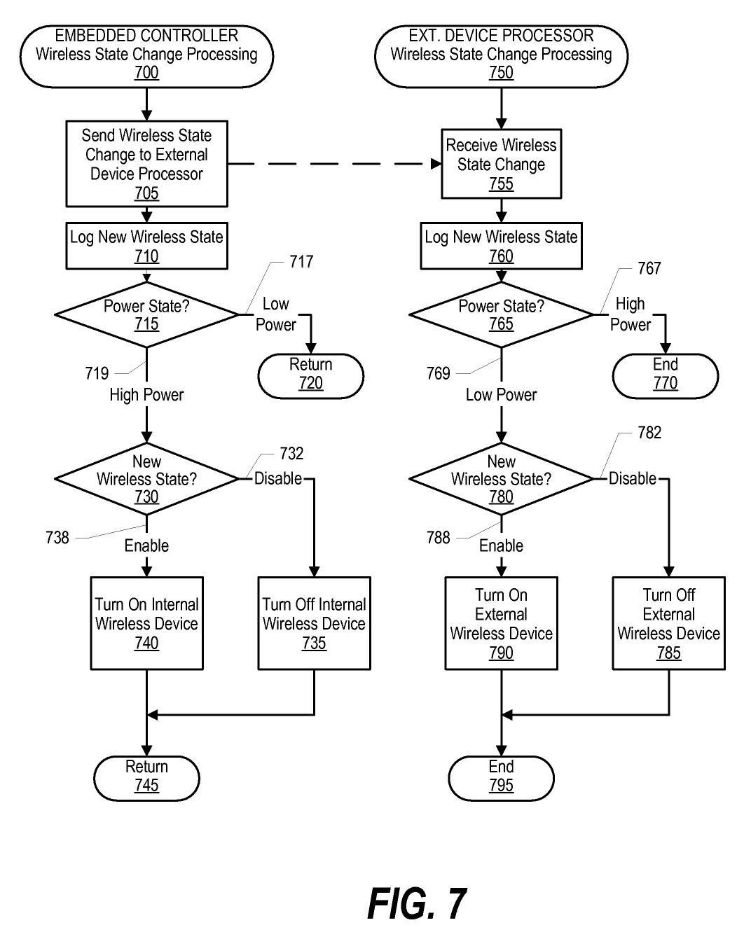

Computer system 200 includes embedded controller 230, which monitors wireless hardware switch 270 for wireless state changes. For example, computer system 200 may include a button that a user may depress in order to enable or disable the wireless state. Embedded controller 230 utilizes system management bus (SMBus) 275 to send wireless state change indicators information to external processor 215. In turn, external processor 215 logs the wireless state change information and, when computer system is in a low power state, external processor 215 enables/disables external wireless device accordingly (see FIG. 7 and corresponding text for further details). In one embodiment, computer system 200 may send the wireless state change indicator to external slot device 210 through other means, such as a hardwired signal.

Embedded controller 260 also controls power to internal wireless device 250 via power control 280 based upon computer system 200's power state. In addition, embedded controller 230 informs power controller 260 as to computer system 200's power state, such as a high power state or low power state. In turn, power controller 260 supplies power to external slot device 210 through power line 265 when computer system 200 is in the high power state and the low power state. When in the high power state, external processor 215 disables external wireless device 220 via power control 270 and logs wireless state change commands from embedded controller 230 and ICH 290. When in the low power state, external processor 215 enables external wireless device 220 based upon computer system 200's wireless state.

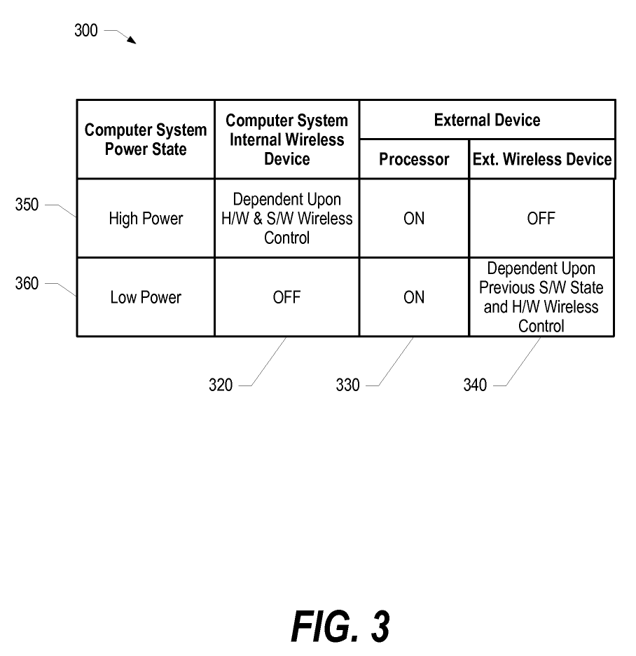

FIG. 3 is a table showing various configurations of an internal wireless device and components included on an external slot device. Table 300 includes rows 350 and 360, which include an internal wireless device's state and an external device's state when a computer system is in either a high power state (row 350) or a low power state (row 360).

Row 350 shows that when the computer system is in a high power state, the internal wireless device's state is dependent upon the computer system's wireless state based upon hardware or software wireless control (column 320). Column 330 shows that the external device's processor is on in order to receive and log wireless state changes from the computer system. And, although the external device's processor is on, the external wireless device remains off in order to not conflict with the internal wireless device (column 340).

Row 360 shows that when the computer system is in a low power state, the internal device is turned off (column 320). Column 330 shows that the external device's processor remains on in the low power state, and column 340 shows that the external wireless device's state is dependent upon a wireless state prior to entering the low power state, and is also dependent upon the computer system's hardware wireless state control. For example, if a computer system's wireless state was enabled prior to entering the low power state, the external device's processor enables the external wireless device once the computer system enters the low power state. In this example, if a user depresses a wireless control switch to disable the wireless state, the external device's processor, in turn, disables the external wireless device.

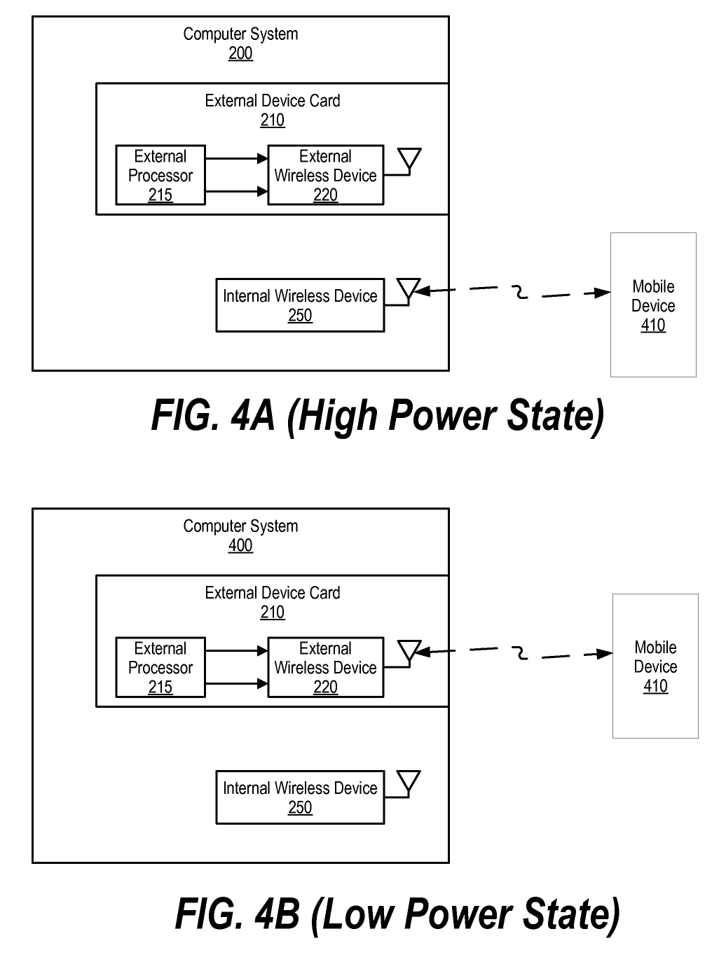

FIG. 4A is a diagram showing a computer system communicating with a mobile device in a high power state through an internal wireless device. Computer system 200 includes internal wireless device 250 and a slot that is adapted to receive external slot device 210, which includes external processor 215 and external wireless device 220.

FIG. 4A shows that when computer system 200 is in a high power state, computer system 200 communicates with mobile device 410 through internal wireless device 250. In order to ensure that external wireless device 220 does not interfere with these communications, external processor 215 turns off external wireless device 220 when computer system 200 is in the high power state.

FIG. 4B is a diagram showing a computer system communicating with a mobile device in a low power state through an external slot device's external wireless device. When computer system 200 enters a low power state, FIG. 4B shows that computer system 200 communicates with mobile device 410 through external wireless device 220. In order to ensure that internal wireless device 250 does not interfere with these communications, computer system 200 turns off internal wireless device 250 when computer system 200 is in the low power state.

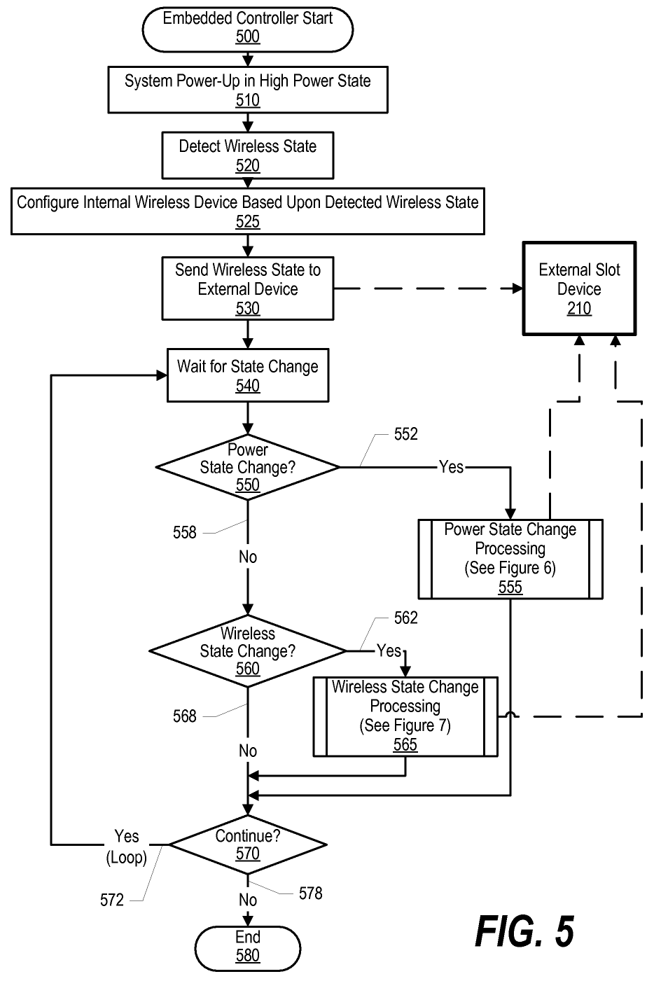

FIG. 5 is a high-level flowchart showing steps taken in configuring a computer system's internal wireless device and an external wireless device based upon the computer system's power state and wireless state. A computer system communicates with a mobile device either through the computer system's internal wireless device or the computer system's external wireless device, such as an ExpressCard. In one embodiment, in order to adhere to particular wireless standards, the computer system ensures that both wireless devices are not enabled concurrently. Meaning, either the internal wireless device is enabled or the external wireless device is enabled, but both devices are not simultaneously enabled.

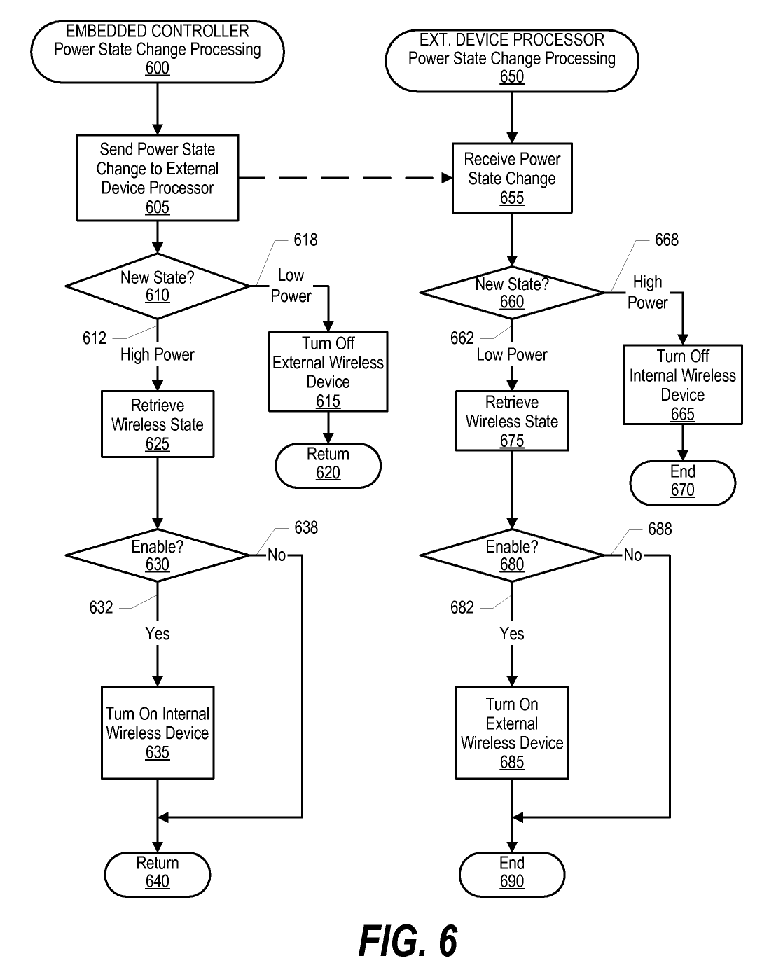

Processing commences at 500, whereupon the computer system powers up in a high power state at step 510. At step 520, processing detects a wireless state, such as through a hardware wireless control (switch) or a software wireless control (e.g., user interface window). Processing configures the computer system's internal wireless device at step 525, such as enabling an internal Bluetooth device. Processing, at step 530, sends the detected wireless state to external slot device 210. External slot device 210 is the same as that shown in FIG. 2, such as an ExpressCard. Since the computer system is currently in a high power state, a processor included in external slot device 210 logs the wireless state such that when the computer system enters a low power state, the processor may retrieve the logged wireless state and enable/disable the external slot device 210's wireless device based upon the logged wireless state (see FIG. 6 and corresponding text for further details).

Processing waits for a state change at step 540, which may be a power state change (e.g., high power to low power) or a wireless state change (e.g., enabled to disabled). When processing detects a state change, a determination is made as to whether the state change was a power state change (decision 550). If the state change was a power state change, decision 550 branches to “Yes” branch 552 whereupon processing proceeds through a series of steps to communicate the state changes to external slot device 210 as well as configure the computer system's internal wireless device accordingly (pre-defined process block 555, see FIG. 6 and corresponding text for further details).

On the other hand, if the state change is not a power state change, decision 550 branches to “No” branch 558 whereupon a determination is made as to whether the state change is a wireless state change (decision 560). For example, a user may have depressed a wireless control switch to turn off the wireless device. If the state change is a wireless state change, decision 560 branches to “Yes” branch 562, whereupon processing proceeds through a series of steps to communicate the wireless state changes to external slot device 210 as well as configure the computer system's internal wireless device accordingly (pre-defined process block 565, see FIG. 7 and corresponding text for further details).

A determination is made as to whether to continue monitoring the computer system's state changes (decision 570). If processing should continue monitoring state changes, decision 570 branches to “Yes” branch 572, which loops back to continue monitoring state changes and performing actions accordingly. This looping continues until processing should terminate, such as when the computer system turns off, at which point decision 570 branches to “No” branch 578 and processing ends at 580.

FIG. 6 is a flowchart showing steps taken in configuring an internal wireless device and an external wireless device based upon a power state change.

Processing detected a power state change in FIG. 5, such as a computer system transitioning from a high power state to a low power state (e.g., S3, S4, or S5 state). FIG. 6 shows steps taken in the computer system's embedded controller configuring an internal wireless device accordingly as well as an external slot device's processor configuring an external wireless device accordingly.

Embedded controller processing commences at 600, whereupon the embedded controller informs the external slot device of the power state change at step 605. External device processing commences at 650, whereupon the external device receives the power state change at step 655.

In one embodiment, the embedded controller sends a power state change indicator to the external slot device, which may be a software message or a hardwired signal.

At the embedded controller, the embedded controller determines whether the new power state is a low power state or a high power state (decision 610). If the new power state is a low power state, decision 610 branches to “Low Power” branch 618, whereupon the embedded controller turns off the internal wireless device at step 615 and returns at 620.

On the other hand, if the new power state is a high power state, decision 610 branches to “High Power” state 612, whereupon processing retrieves a wireless state at step 625. In one embodiment, the wireless state is dependent upon the combination of a hardware wireless control and a software wireless control.

A determination is made as to whether the wireless state is in a wireless enabled state or a wireless disabled state (decision 630). If the wireless state is in a wireless enabled state, decision 630 branches to “Yes” branch 632 whereupon processing enables the internal wireless device at step 635 and returns at 640. On the other hand, if the wireless state is in a wireless disabled state, decision 630 branches to “No” branch 638, thus keeping the internal wireless device disabled and returning at 640.

At the external device, the external device determines whether the new power state is a low power state or a high power state (decision 660). If the new power state is a high power state, decision 660 branches to “High Power” branch 668, whereupon the external device turns off the external wireless device at step 665 and ends at 670. As can be seen, steps 615 and 665 ensure that both the internal wireless device and the external wireless device are not turned on at the same time.

On the other hand, if the new power state is a low power state, decision 660 branches to “Low Power” state 662, whereupon processing retrieves a logged wireless state at step 675. The external device logs the wireless state regardless of whether the computer system is in the low power state or the high power state in order for the external device to place the external wireless device in the correct wireless state when the computer system changes to the low power state (see FIG. 7 and corresponding text for further details).

A determination is made as to whether the wireless state is in a wireless enabled state or a wireless disabled state (decision 680). If the wireless state is in a wireless enabled state, decision 680 branches to “Yes” branch 682 whereupon processing enables the external wireless device at step 685 and ends at 690. On the other hand, if the wireless state is in a wireless disabled state, decision 680 branches to “No” branch 688, thus keeping the external wireless device disabled.

FIG. 7 is a flowchart showing steps taken in configuring an internal wireless device and an external wireless device based upon a wireless state change. Processing detected a wireless state change in FIG. 5, such as transitioning from a wireless enabled state to a wireless disabled state. FIG. 7 shows steps taken in the computer system's embedded controller configuring the internal wireless device accordingly as well as the external slot device's processor configuring the external wireless device accordingly.

Embedded controller processing commences at 700, whereupon the embedded controller sends the wireless state change to the external device at step 705 and logs the new wireless state at step 710. External device processing commences at 750, whereupon the external device receives the wireless state change at step 755 and logs the new wireless state at step 760. As can be seen, steps 705-710 and 755-760 occur regardless of the computer system's power state due to the fact that both the embedded controller and the external device are required to track the wireless state change in order to properly enable/disable their corresponding wireless device when a power state change occurs (see FIG. 6 and corresponding text for further details).

At the embedded controller, a determination is made as to whether the power state is in a high power state or a low power state (decision 715). If the power state is in a low power state, decision 715 branches to “Low Power” branch 717 whereupon processing returns at 720 due to the fact that in a low power state, the internal wireless device is turned off.

On the other hand, if the power state is in a high power state, decision 715 branches to “High Power” branch 719, whereupon a determination is made as to the new wireless state (decision 730). If the new wireless state is a wireless enabled state, decision 730 branches to “Enable” branch 738 whereupon processing turns on the internal wireless device at step 740 and returns at 745. On the other hand, if the new wireless state is a wireless disabled state, decision 730 branches to “Disable” state 732, whereupon processing turns off the internal device at step 735 and returns at 745.

At the external device, a determination is made as to whether the power state is in a high power state or a low power state (decision 765). If the power state is in a high power state, decision 765 branches to “High Power” branch 767 whereupon processing ends at 770 due to the fact that in a high power state, the external wireless device is turned off.

On the other hand, if the power state is in a low power state, decision 765 branches to “Low Power” branch 769, whereupon a determination is made as to the new wireless state (decision 780). If the new wireless state is a wireless enabled state, decision 780 branches to “Enable” branch 788 whereupon processing turns on the external wireless device at step 790 and ends at 795. On the other hand, if the new wireless state is a wireless disabled state, decision 780 branches to “Disable” state 782, whereupon processing turns off the internal device at step 785 and ends at 795.

One of the preferred implementations of the invention is a client application, namely, a set of instructions (program code) or other functional descriptive material in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive). Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps. Functional descriptive material is information that imparts functionality to a machine. Functional descriptive material includes, but is not limited to, computer programs, instructions, rules, facts, definitions of computable functions, objects, and data structures.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A machine-implemented method comprising:
detecting a power state change in a computer system;
determining that the power state change puts the computer system in a low power state; and
in response to determining that the power state change puts the computer system in the low power state, informing an external slot device to enable an external wireless device included in the external slot device.

2. The method of claim 1 further comprising:
in the low power state, detecting a wireless state change from a hardware wireless control; and
in the low power state, in response to detecting the wireless state change, informing the external slot device to configure the external wireless device based upon the wireless state change.

3. The method of claim 1 wherein a power state change indicator is provided to the external slot device, the method further comprising:
detecting a subsequent power state change that puts the computer system in a high power state; and
in response to detecting that the subsequent power state change puts the computer system in a high power state, sending a subsequent power state change indicator to the external slot device to turn off the external wireless device.

4. The method of claim 3 further comprising:
in the high power state, detecting a wireless state change; and
in the high power state, in response to detecting the wireless state change, sending a wireless state change indicator to the external slot device, wherein the external slot device is adapted to log the wireless state change.

5. The method of claim 4 further comprising:
in response to receiving the power state change indicator, retrieving, at the external slot device, the logged wireless state change; and
configuring the external wireless device based upon the logged wireless state change.

6. The method of claim 1 wherein the computer system provides power to the external slot device in the low power state.

7. The method of claim 1 wherein the computer system informs the external slot device through a system management bus.

8. A computer program product stored in a computer readable medium, comprising functional descriptive material that, when executed by an information handling system, causes the information handling system to perform actions that include:
detecting a power state change in a computer system;
determining that the power state change puts the computer system in a low power state; and
in response to determining that the power state change puts the computer system in the low power state, informing an external slot device to enable an external wireless device included in the external slot device.

9. The computer program product of claim 8 wherein the information handling system further performs actions that include:
in the low power state, detecting a wireless state change from a hardware wireless control; and
in the low power state, in response to detecting the wireless state change, informing the external slot device to configure the external wireless device based upon the wireless state change.

10. The computer program product of claim 8 wherein a power state change indicator is provided to the external slot device, the information handling system further performing actions that include:
detecting a subsequent power state change that puts the computer system in a high power state; and
in response to detecting that the subsequent power state change puts the computer system in a high power state, sending a subsequent power state change indicator to the external slot device to turn off the external wireless device.

11. The computer program product of claim 10 wherein the information handling system further performs actions that include:
in the high power state, detecting a wireless state change; and
in the high power state, in response to detecting the wireless state change, sending a wireless state change indicator to the external slot device, wherein the external slot device is adapted to log the wireless state change.

12. The computer program product of claim 11 wherein the information handling system further performs actions that include:
in response to receiving the power state change indicator, retrieving, at the external slot device, the logged wireless state change; and
configuring the external wireless device based upon the logged wireless state change.

13. The computer program product of claim 8 wherein the computer system provides power to the external slot device in the low power state.

14. The computer program product of claim 8 wherein the computer system informs the external slot device through a system management bus.

15. An information handling device comprising:
one or more processors;
a memory accessible by at least one of the processors;
a nonvolatile storage area accessible by at least one of the processors;
a set of instructions stored in the memory and executed by at least one of the processors in order to perform actions of:
detecting a power state change in a computer system;
determining that the power state change puts the computer system in a low power state; and
in response to determining that the power state change puts the computer system in the low power state, informing an external slot device to enable an external wireless device included in the external slot device.

16. The information handling device of claim 15 wherein the information handling system further performs actions that include:
in the low power state, detecting a wireless state change from a hardware wireless control; and
in the low power state, in response to detecting the wireless state change, informing the external slot device to configure the external wireless device based upon the wireless state change.

17. The information handling device of claim 15 wherein a power state change indicator is provided to the external slot device, the information handling system further performs actions that include:
detecting a subsequent power state change that puts the computer system in a high power state; and
in response to detecting that the subsequent power state change puts the computer system in a high power state, sending a subsequent power state change indicator to the external slot device to turn off the external wireless device.

18. The information handling device of claim 17 wherein the information handling system further performs actions that include:
in the high power state, detecting a wireless state change; and
in the high power state, in response to detecting the wireless state change, sending a wireless state change indicator to the external slot device, wherein the external slot device is adapted to log the wireless state change.

19. The information handling device of claim 18 wherein the information handling system further performs actions that include:
in response to receiving the power state change indicator, retrieving, at the external slot device, the logged wireless state change; and
configuring the external wireless device based upon the logged wireless state change.

20. The information handling device of claim 15 wherein the computer system provides power to the external slot device in the low power state.

21. A machine-implemented method comprising:
receiving, at an external slot device, an indication that a computer system is entering a low power state, the external slot device attached to the computer system; and
enabling an external wireless device included in the external slot device based upon receiving the indication that the computer system entering the low power state.
